(19) United States
(12) Patent Application Publication
(10) Pub. No.: US 2007/0028452 A1
(43) Pub. Date: Feb. 8, 2007

(54) Device for opening packages

(76) Inventors: Michael LaFauci, Brooklyn, NY (US); Dawn D'Alessio, Staten Island, NY (US)

Correspondence Address: GOTTLIEB RACKMAN & REISMAN PC, 270 MADISON AVENUE, 8TH FLOOR, NEW YORK, NY, 100160601, US

(21) Appl. No.: 11/454,747

(22) Filed: Jun. 16, 2006

Related U.S. Application Data
(60) Provisional application No. 60/705,878, filed on Aug. 5, 2005.

(51) Int. Cl. B26B 3/00

(52) U.S. Cl. 30/142

(57) ABSTRACT

A small, safe, and disposable package-opening device with the dimensions of a credit card or smaller that can be attached to a cardboard package for facilitating opening of the package. In one embodiment, the device has a notch in a cutting edge to form a point to pierce the package to initiate its opening.

### RELATED APPLICATIONS

This application claims priority to U.S. provisional application Ser. No. 60/705,878 filed Aug. 5, 2005 and incorporated herein by reference.

### BACKGROUND OF THE INVENTION

A. Field of the Invention

This invention relates to devices for opening packages, and more particularly, to a small cutting device that can be included with a product such as a book or any other item sent in a cardboard package. The device can be used to open the package it is included with when the device is attached to the exterior of the package.

B. Description of the Prior Art

Most cardboard packages today are manufactured with rip-away features created by indentations. These rip-away features often do not succeed, and the person opening the package must resort to scissors, a knife, or a box cutter. A traditional device for opening packages is all metal and can be quite dangerous since the cutting edge is sharp.

The disadvantages of the prior art devices are that they are heavy, sharp, metal implements that can cause serious injuries if used carelessly. Furthermore, existing devices often cannot be packaged with shipped products due to mailing restrictions and the increased package weight and, therefore, shipping cost.

What is needed is a small, light-weight device for opening packages safely that can be packaged with the products as a “built-in” package opener.

### SUMMARY OF THE INVENTION

The present invention is a device for opening packages that in one preferred and illustrated embodiment has the dimensions of a credit card, in length, width and thickness. Such dimensions (preferably one and three quarter inches (height) and two and a half inches (width)) allow the device to be included with a shipped product, preferably by attaching the device to the outside of the packaging in which the product is shipped.

The device can be smaller than a credit card, so that it can be packaged with very small products, such as compact discs, digital video discs, videotapes, and computer or video games. The preferred dimensions for this embodiment are one inch (height) by one and a quarter inches (width). Each embodiment of the device is typically affixed to the outside of a cardboard package by means of a releasable adhesive such that, when the device is removed, the adhesive remains on the package and not on the device. One edge of the device has a notch with a sharp edge for the purpose of slicing the package. The notch is preferably circular in shape, but it can be of a different shape suitable for slicing the package open. The edge is preferably a pointed edge that has a sharp point for piercing the packaging. The pointed edge and the sharp point are formed by the notch, the notch preferably being in the shape of a semi-circle or closer to a complete circle. Together with the edge of the device, the notch shaped as a near-complete circle produces a sharp pointed edge suitable for piercing and cutting the packaging.

In another embodiment of the present invention, the device can be sized so that it can be easily placed on a key ring. Suitable dimensions are one and one half inches (height) by two inches (width).

Each of the embodiments of the device can be fashioned to contain an indent so that the user's finger does not slip off of the device when it is used to slice open a box. The circular notch of the device can be supplied with a metal covering attached to the notch to allow for easy slicing; the metal can be on the circular notch alone or along the entire cutting edge. Plastic can cover the metal before use and can be designed to fall away when the cutter is used.

The slicing element of the device can be made retractable, enclosed within a housing and sliding out when needed. The device is ideally made from a plastic that is hard enough to create a cutting edge and rigid enough so that it does not bend during cutting. The cutting edge is sharp enough to slice through cardboard, tape and labels. Alternatively, the cutting edge in any embodiment of the invention may be covered with metal to aid in cutting.

The plastic of the device of the present invention is easy to use, and the edge of the notch, whether or not with a metal component, is not as sharp as that of a traditional device for opening packages. Since the device is preferably affixed to the package, there is no need for the person opening the package to search for scissors or knives. The user can keep the device and use it to open packages in the future. Moreover, the smaller, key-fob sized device is immediately accessible by individuals who carry their keys with them if the key-fob sized device is carried on a key chain. The smallest embodiment of the device (smaller than the key-fob embodiment) is suitable for placement on CD and DVD packaging.

Advertising material may be placed on each embodiment of the device for a fee (or without a fee). This advertising material can take the form of a third party's trademarks, coupons, and/or gift cards. In this fashion, the sender of the package or any third party that buys advertising space on the device will increase its brand recognition and continue to gain the customer's loyalty through providing an extra benefit to the customer. An alternative way of advertising using the present invention is manufacturing the device in the shape of a logo or trademark, with one straight sharpened edge for opening packages. This device is preferably the size of a credit card or smaller, and the logo or trademark shape can be any complex line or curvilinear shape starting at the first end of the sharpened edge and ending at the second end of the sharpened edge. In addition to being usable by companies or businesses, the device may be used by schools, teams, cities, or states.

Each embodiment of the device may be saved or disposed of by the customer. The small size of the cutting device is designed so that the recipient of the package can easily save the device in a wallet, purse, backpack or, in case of the second smallest embodiment, on a key ring.

### BRIEF DESCRIPTION OF THE DRAWINGS

FIG. 1 is a perspective view of one embodiment of the cutting device of the present application;

FIG. 2 is a perspective view of the cutting device of FIG. 1 affixed to a package;

FIG. 3 is a cross-sectional view along line 3-3 of the cutting device of FIG. 2, showing the finger of the user in a position to peel the device off the package and showing the finger of the user peeling the device in phantom lines;

FIG. 4 is an exploded perspective view of an alternative version of the cutting device having a metal strip with a cutting element;

FIG. 5 is a perspective view of the cutting device of FIG. 4;

FIG. 6 is a cross-sectional view along line 6C-6C of the cutting device of FIG. 5;

FIG. 7 is a cross-sectional view along line 7D-7D of the cutting device of FIG. 5;

FIG. 8 is a perspective view of a portion of a further cutting device having a notch and a cooperating metal strip disposed therein;

FIG. 9 is a perspective view of still another embodiment of the cutting device having a notch and an indent capable of receiving a finger;

FIG. 10 is a perspective view of yet a further embodiment of the cutting device having a curved metal strip 41D applied to the device where notch 43D is formed on the side of device 21D opposite to the side where finger indent 47D is formed;

FIG. 11 is a cross-sectional view along line 11H-11H of the cutting device of FIG. 10 showing a user's finger in place;

FIG. 12 is a cross-sectional view along line 12I-12I of the cutting device of FIG. 10;

FIG. 13 is a perspective exploded view of a retractable cutting device;

FIG. 14 is a view of the assembled retractable cutting device of FIG. 13;

FIG. 15 is a view of the retractable cutting device of FIG. 13 showing the use of the retractable cutting device;

FIG. 16 is a cross-sectional view along line 16-16 of the cutting device of FIG. 14;

FIG. 17 is a cross-sectional view along line 17-17 of the cutting device of FIG. 15;

FIG. 18 is a perspective view of another embodiment of the cutting device;

FIG. 19 is a top view of yet another embodiment of the cutting device;

FIG. 20 is a cross-sectional view along line 20-20 of the cutting device of FIG. 18.

FIG. 21 is a top view of the embodiment of the cutting device in the shape of a circle;

FIG. 22 is a cross-sectional view along line 22-22 of the cutting device of FIG. 21;

FIG. 23 is a top view of the embodiment of the cutting device in the shape of a triangle;

FIG. 24 is a cross-sectional view along line 24-24 of the cutting device of FIG. 23;

FIG. 25 is a top view of the embodiment of the cutting device defined by a zigzagged line;

FIG. 26 is a perspective view of the embodiment of the cutting device defined by a curvilinear line;

FIG. 27 is a top view of the embodiment of the cutting device in the shape of a square; and

FIG. 28 is a top view of the embodiment of the cutting device in the shape of an octagon.

### DETAILED DESCRIPTION OF THE PREFERRED EMBODIMENT

FIG. 1 illustrates a cutting device 21 of the present invention prior to being affixed to a cardboard package 23 by means of adhesive 25. The cutting device 21 is preferably rectangular-shaped and, in one embodiment, is of a size similar to that of a credit card. In another embodiment, the cutting device 21 is somewhat smaller than a credit card, and, in a third embodiment, the cutting device 21 is of a size suitable for placement on a key ring. The cutting device 21 has lengthwise edges 27 and widthwise edges 29. Preferably, one of the lengthwise edges 27 is formed with a notch 31 for defining a cutting element 33 of the cutting device 21.

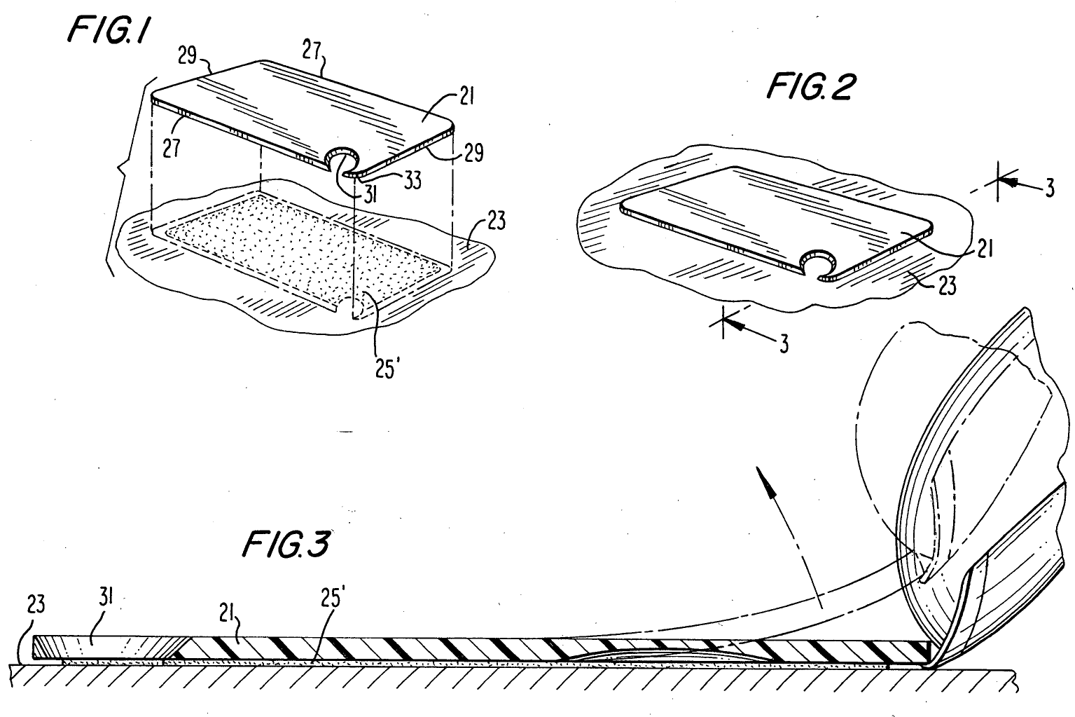

FIG. 2 illustrates the cutting device 21 affixed to a package 23. FIG. 3 is a cross-sectional view of the cutting device 21 taken along line 3-3 of FIG. 2 and illustrating removal of the cutting device 21 from the surface of the package 23.

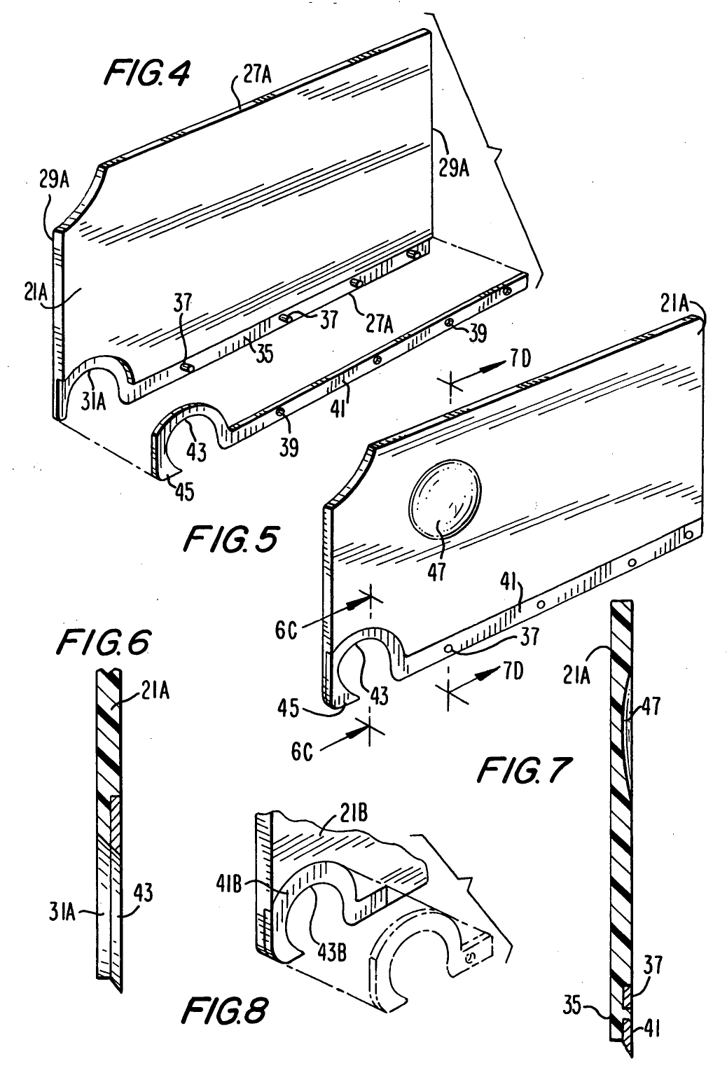

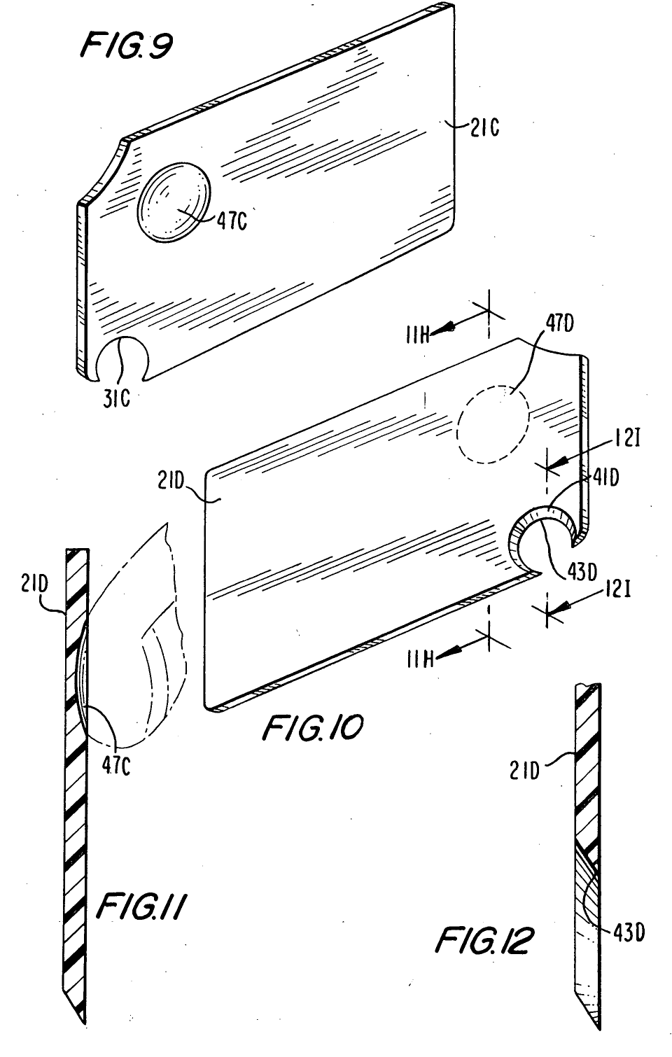

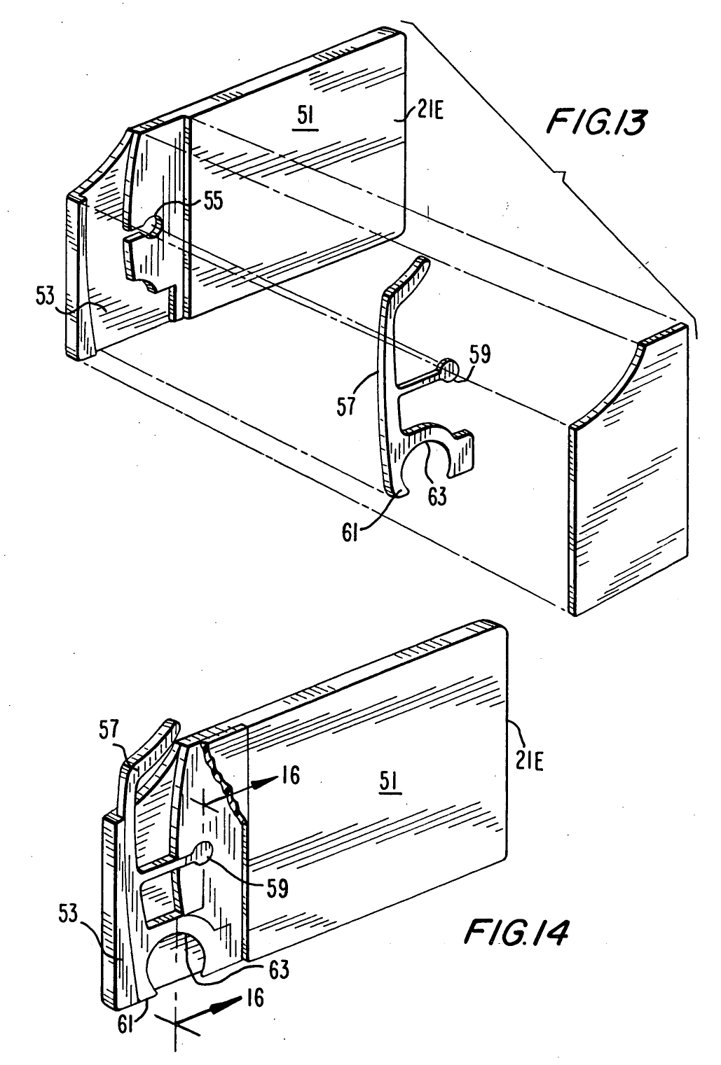

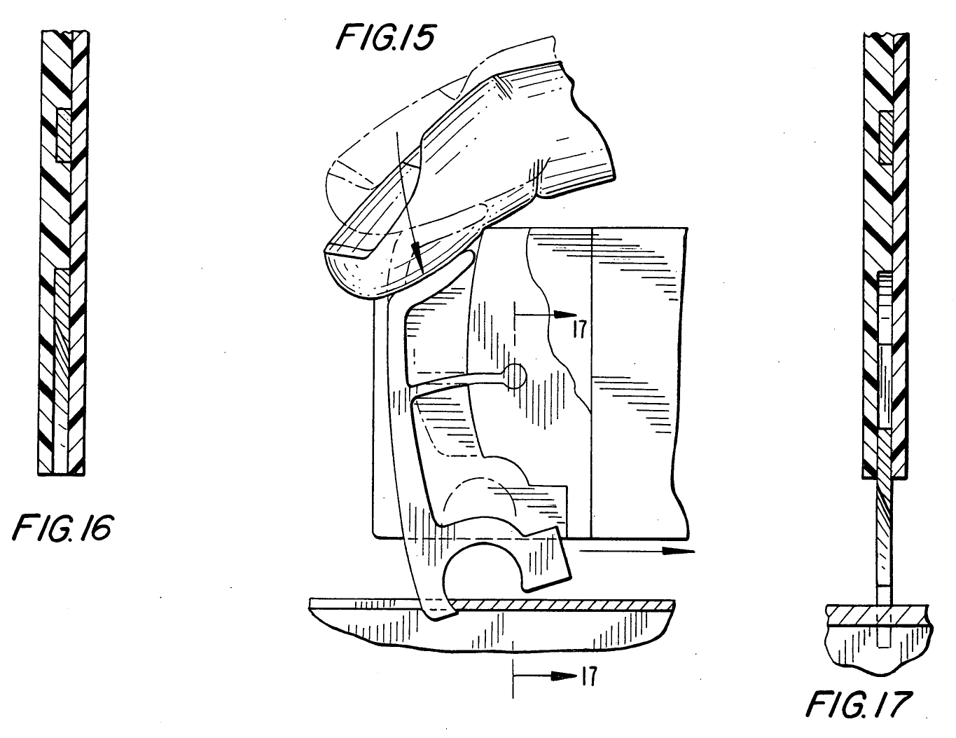

An alternative embodiment of the inventive cutting device, identified at 21A, is illustrated in FIG. 4, which is an exploded perspective view of the cutting device 21A. The cutting device 21A is preferably formed of plastic. It has lengthwise edges 27A, and one of the lengthwise edges is formed with a plastic strip 35 extending therealong and defining a notch 31A. The strip 35 includes a plurality of plugs 37 for receiving openings 39 of a corresponding strip 41, which is preferably made of metal. The metal strip 41 is formed with a notch 43 that corresponds to the notch 31A of the plastic strip 35. The notch 43 defines a cutting element 45. As illustrated in FIG. 5, the metal strip 41 of the cutting device 21A is fitted over the plastic strip 35. The cutting device 21A may include an indent 47 designed for receiving the finger of an individual during use, to prevent the finger from slipping off the cutting device. A similar indent may be included in every embodiment of the present invention. Cross-sectional views of the cutting device 21A taken along line C-C of FIG. 5 and along line D-D of FIG. 5 are illustrated in FIG. 6 and FIG. 7 respectively.

A part of yet another embodiment of the cutting device, identified as 21B, is shown in FIG. 8, which is a perspective view of this embodiment. In this embodiment, a curved metal strip 41B is applied to the cutting device 21B and runs along only the curved edge of the device 21B, where a notch 43B is formed.

FIG. 9 is a perspective view of still another embodiment of the inventive cutting device identified as 21C. The cutting device 21C includes a notch 31C and an indent 47C, capable of receiving a user's finger, but does not include a metal strip along one of the edges. In this embodiment, device 21C is made of hard plastic suitable for use in cutting. Cross-sectional views of the cutting device 21C taken along line H-H of FIG. 9 and along line I-I of FIG. 9 are illustrated in FIG. 11 and FIG. 12 respectively.

FIG. 10 is a perspective view of yet a further embodiment of the inventive cutting device, identified at 21D. In this embodiment, a curved metal strip 41D may be applied to the cutting device 21D where the notch 43D is formed on the side of device 21D opposite to the side where a finger indent 47D, capable of receiving the user's finger, is formed.

FIG. 13 is a perspective view of a retractable cutting device 21E. Device 21E comprises a body 51, which is a housing, and an extending element 53. Body 51 is formed with a key slot 55 adjacent to the element 53. A cutting tool 57 is shown selectively disposable over extending element 53. The cutting tool 57 includes a pin element 59, which engages and is received by the key slot 55 as illustrated in FIG. 14. The cutting tool 57 also includes a cutting element 61 formed by a notch 63 that is retractable up and down due to the pivoting action of the pin element 59 (see FIG. 15). Cross-sectional views of the cutting device 21E taken along line L-L of FIG. 14 and along line N-N of FIG. 15 are illustrated in FIG. 16 and FIG. 17 respectively.

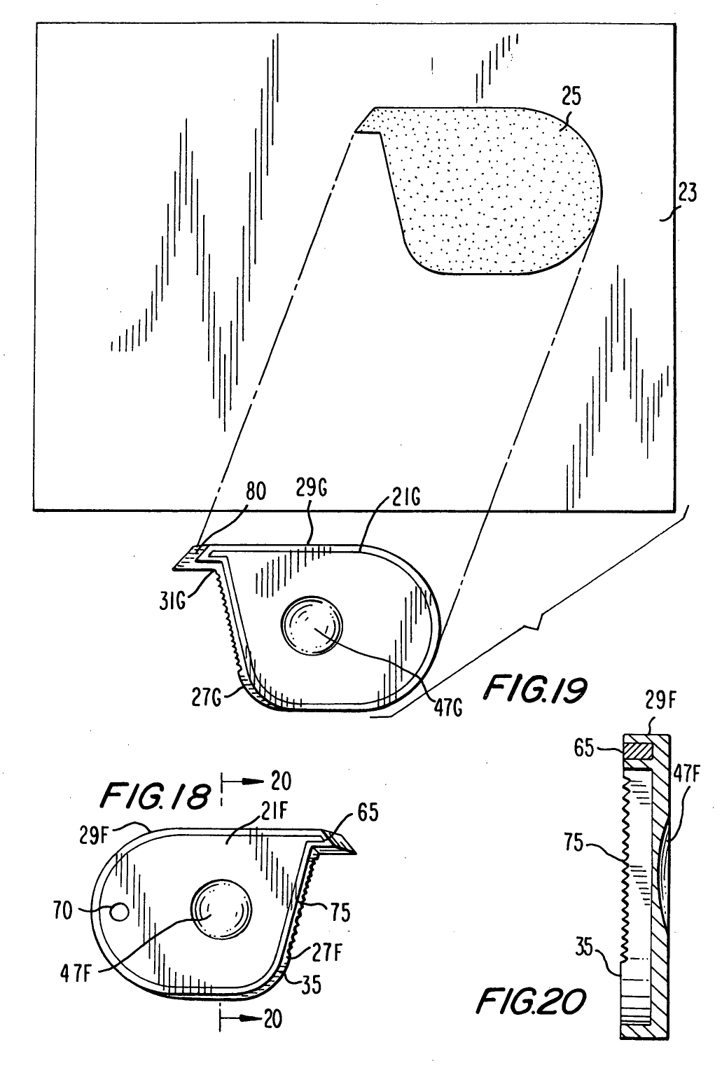

FIG. 18 illustrates a different embodiment of the device. A cutting device 21F has lengthwise edges 27F and widthwise edges 29F. A strip 35 extends along the circumference of the cutting device 21F, preferably perpendicularly to the lengthwise edges 27F and widthwise edges 29F of the device, forming a piercing element 65. The piercing element 65 is used to puncture cardboard or mailing tape, and the piercing element 65 is preferably shaped like the point of a chisel. The strip 35 defines an edge for cutting cardboard and may include a plurality of recesses defining a serrated edge 75 for opening packages. The cutting device 21F is preferably of a size similar to a credit card, but the cutting device 21F may be somewhat smaller than a credit card, or the cutting device 21F may be of a size suitable for placement on a key ring. An aperture 70 may be included for placement on a key ring. Furthermore, an indent 47F to receive the user's finger during use may be disposed on the cutting device 21F.

FIG. 19 illustrates yet another embodiment of the device. A cutting device 21G is affixed to a cardboard package 23 by means of adhesive 25. The cutting device 21G is preferably of a size similar to a credit card, but the cutting device 21G may be also smaller than a credit card, or the cutting device 21G may be of a size suitable for placement on a key ring. The cutting device 21G has lengthwise edges 27G and widthwise edges 29G. One of the lengthwise edges 27G is formed with a notch 31G, defining a cutting element 80 with an edge having a plurality of recesses, i.e., a serrated edge. The cutting device 21G may further include an indent 47G disposed on the cutting device 21G to receive the user's finger during use.

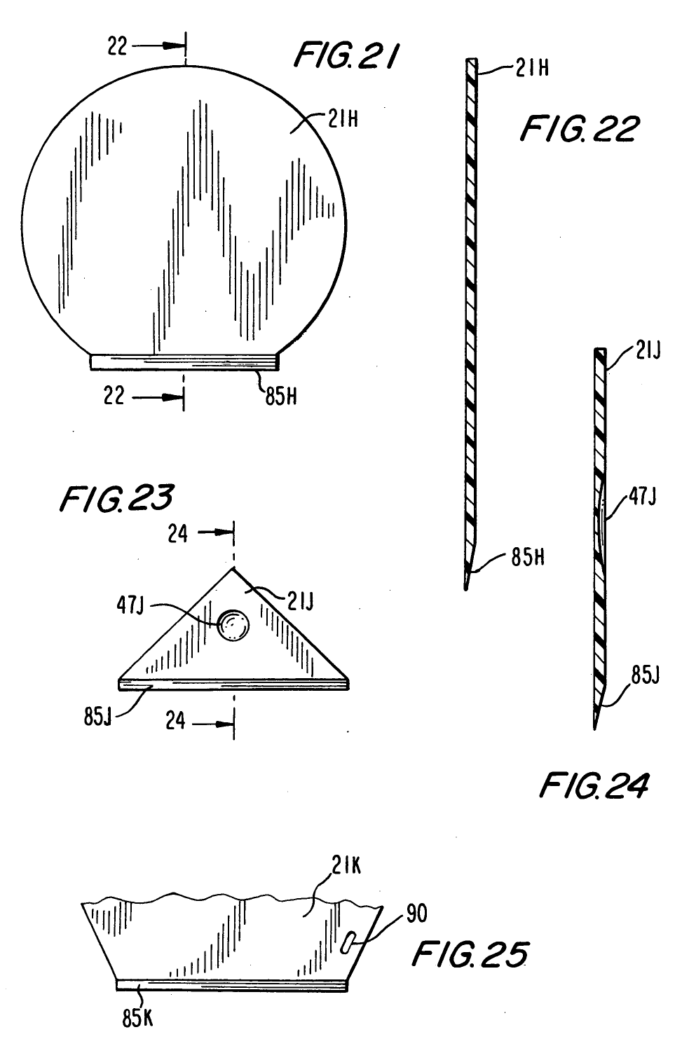

FIGS. 21-28 illustrate embodiments of the device that can be manufactured in the shape of a logo or trademark, with one straight sharpened edge for opening packages. The logo or trademark shape can be any complex line or curvilinear shape, for example, starting at the first end of the sharpened edge and ending at the second end of the sharpened edge. The logo and trademark shapes can be manufactured from plastic of the appropriate color, or the shapes can be colored with the appropriate logo and/or trademark colors after the manufacturing of the device to complete the visual appearance of the device. FIGS. 21-22 show a one-piece, roughly elliptical (from the top view shown in FIG. 21) cutting device 21H with a sharp, straight edge 85H. FIGS. 23-24 show a one-piece, roughly triangular (from the top view shown in FIG. 23) cutting device 21J with a sharp, straight edge 85J and an indent 47J disposed on the cutting device 21J to receive the user's finger during use. FIG. 25 shows a one-piece cutting device 21K with a sharp, straight edge 85K and an aperture 90 for placement of the cutting device 21K on a key ring. The shape of the cutting device 21K is outlined by a freeform zigzagged line.

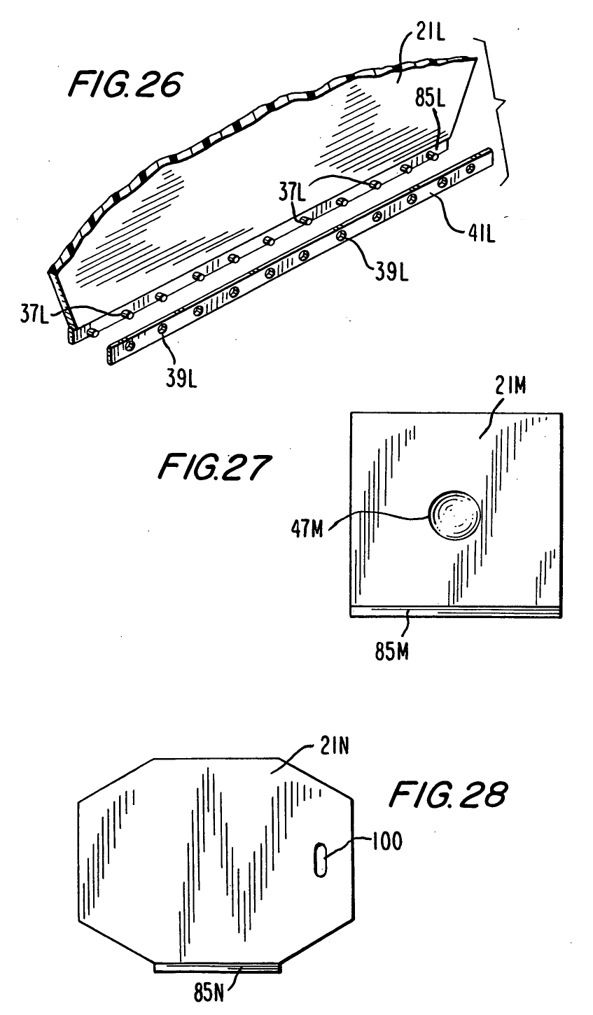

FIG. 26 shows another freeform-line-shaped cutting device 21L, which can be made in the form of any trademark or logo, including those of businesses, schools, sports teams, or cities. This embodiment of the device has one straight edge with a plastic strip 85 that has a plurality of plugs 37L for receiving openings 39L of a corresponding strip 41L, which is preferably made of metal. As illustrated in FIG. 26, the metal strip 41L of the cutting device 21L is fitted over the plastic strip 85. The edge with the sharp metal strip 41L is used to open packages.

FIGS. 27-28 show yet other embodiments of the inventive cutting device for opening packages that can be manufactured in the shape of a logo or trademark. FIG. 27 shows the top view of a one-piece, square cutting device 21M with a sharp, straight edge 85M and an indent 47M disposed on the cutting device 21M to receive the user's finger during use. FIG. 28 shows a one-piece, octagonal cutting device 21N with a sharp, straight edge 85N and an aperture 100 for placement of the cutting device 21N on a key ring.

The logo or trademark can also be placed on one or more surfaces of any of the embodiments of the inventive cutting device depicted and described herein.

A feature of the several embodiments is that the cutting tool is flat and cheap to manufacture, so that it can be affixed to a package to facilitate its opening and then even discarded if desired. The “system” if the invention is thus a combined package and device for opening packages.

Although the invention has been described in terms of particular embodiments, the embodiments are merely illustrative of an application of the principles of the invention. Numerous modifications may be made and other arrangements may be devised without departing from the spirit and scope of the invention.

What is claimed is:

1. A hand-held device for opening a package having a substantially planar shape and a notch along one edge, said notch and edge forming a sharp piercing point, said notch and point serving as a cutting tool for opening the package.

2. The device of claim 1 wherein said notch has a partially circular edge and the area of said notch is greater than the area of half of the circle that would be enclosed by the edge were it a closed circle.

3. The device of claim 1 wherein said device for opening a package is adapted to be carried on a key ring.

4. The device of claim 1 wherein said device for opening a package includes an indent formed to receive a user's finger during use.

5. A device for opening packages, comprising:
a flat element having an edge and a size no greater than that of a standard credit card;
a strip disposed on said edge and defining a notch; and
a cutting element having a corresponding notch and attached to said strip.

6. The device of claim 5 wherein said strip includes a plurality of plugs and said cutting element includes a plurality of openings cooperating with said plurality of plugs for attaching said cutting element to said strip.

7. The device of claim 5 wherein said flat element includes an indent formed to receive a user's finger during use.

8. The device of claim 7 wherein said indent is disposed on a side of said device opposite to the side to which said cutting element is attached.

9. A device for opening packages, comprising:
a housing formed with a slot; and
an extending element enclosed within said housing and having a flexible pin received by the slot, said extending element also having a cutting tool formed by a notch, wherein the cutting tool is retractably movable with respect to said housing due to the flexing action of the pin.

10. The device of claim 9 wherein said housing includes an indent formed to receive a user's finger during use.

11. A device for opening packages, comprising:
a flat element having an edge and a size no greater than that of a standard credit card; and
a flat strip extending out of the plane of said flat element along said edge, said flat strip forming a piercing element operable by a user to puncture cardboard or mailing tape and having a plurality of recesses defining a serrated edge for cutting cardboard.

12. The device of claim 11 wherein said piercing element is chisel-point-shaped.

13. The device of claim 11 wherein said flat element includes an indent formed to receive a user's finger during use.

14. A system for opening packages, comprising:
a combined package and an opener in the form of a flat element having a size no greater than that of a standard credit card and having at least one edge formed with a notch and a point, said notch and point constituting a cutting tool for opening packages, wherein said opener is affixed to the outside of said package.

15. The system of claim 14 wherein said flat element includes an indent formed to receive a user's finger during use.

16. The method of advertising using a device for opening packages having a flat element having an edge formed with a notch and a point and a size no greater than that of a standard credit card, said notch and point constituting a cutting tool for opening packages, said method comprising:
placing advertising material on at least one side of said flat element; and
displaying the advertising material on the at least one side of the device for opening packages.

17. The method of claim 16 wherein said advertising material is a trademark or logo.

18. The method of claim 17 wherein the shape of the device for opening packages is that of said trademark or logo.

19. The method of claim 16, further comprising the step of attaching said device for opening packages to a package, wherein the at least one side of the device for opening packages is visible.

20. The method of claim 19 wherein attaching said device for opening packages to the package is done by a releasable adhesive.

21. A method of facilitating of opening a shipped package using a system for opening packages, comprising: a combined package and an opener in the form of a flat element having a size no greater than that of a standard credit card and having at least one edge formed with a notch and a point, said notch and point constituting a cutting tool for opening packages, wherein said opener is attachable to the outside of said package, said method comprising:
attaching said opener to the outside of said package; and
shipping said package.

22. A system for opening a package, comprising:
a combined package and an opener in the form of a flat element defined by a first nonlinear edge and having a second linear sharpened edge, said first edge having a first end and a second end, and said second edge beginning at the first end of said first edge and ending at the second end of said second edge, wherein said second edge is operable by a user to open said package, and wherein said opener is affixed to the outside of said package.

23. The system of claim 22 wherein the shape of said flat element is a shape of a logo or trademark.

24. The system of claim 22 wherein said flat element includes an indent formed to receive a user's finger during use.
